(19) United States
(12) Patent Application Publication
(10) Pub. No.: US 2008/0262159 A1
(43) Pub. Date: Oct. 23, 2008

(54) Method of fabricating a power and/or telecommunications cable

(76) Inventors: Jerome Fournier, Lyon (FR); Arnaud Piechaczyk, Lyon (FR); Olivier Pinto, Lyon (FR); Jean-Pierre Pascault, Villeurbanne (FR); Francoise Fenouillot, L'ISLE D'ABEAU (FR); Laurent Tribut, Lyon (FR)

Correspondence Address: SOFER & HAROUN LLP., 317 MADISON AVENUE, SUITE 910, NEW YORK, NY, 10017, US

(21) Appl. No.: 12/080,575

(22) Filed: Apr. 3, 2008

(30) Foreign Application Priority Data
Apr. 5, 2007 (FR) 07 54301

(51) Int. Cl. C08L 67/03

(52) U.S. Cl. 525/165

(57) ABSTRACT

A method of fabricating a power and/or telecommunications cable includes obtaining at least one layer of a material by thermally activating an elastomer composition containing a copolymer of ethylene vinyl acetate, a cyclic polyester oligomer, and a transesterification catalyst, where the material including nodules of polyester.

### RELATED APPLICATION

This application claims the benefit of priority from French Patent Application No. 07 54301, filed on Apr. 5, 2007, the entirety of which is incorporated herein by reference.

### FIELD OF THE INVENTION

The present invention relates to a method of fabricating a power and/or telecommunications cable, and to said cable obtained by said method.

### BACKGROUND OF THE INVENTION

It is well known that incorporating a polyester in an elastomer composition typically makes it possible to improve the chemical resistance of said composition, e.g. resistance to oils.

Nevertheless, such incorporation of polyesters, such as polybutylene terephthalate (PBT) for example, in the elastomer composition does not give mixtures that are satisfactory since those two types of polymer compound are difficult to mix together.

In general, this incompatibility makes it necessary to perform mixing at a temperature higher than the degradation temperature of the elastomer, where said degradation temperature is 220° C. for ethylene vinyl acetate copolymer (EVA), for example.

It is therefore difficult to prepare elastomer compositions including polyesters for the purpose of fabricating insulating layers or protective layers for cables, said layers presenting good mechanical, thermal, and chemical properties.

The technical problem to be solved by the subject matter of the present invention is to propose a method of fabricating a power and/or telecommunications cable including at least one layer of a material obtained from an elastomer composition comprising an ethylene vinyl acetate copolymer and a polyester, said method making it possible to avoid problems of miscibility, in particular while providing thermal, mechanical, and chemical properties that are improved significantly.

The solution to the technical problem posed lies in that the present invention provides a method of fabricating a power and/or telecommunications cable having at least one layer of material obtained by thermally activating an elastomer composition containing an ethylene vinyl acetate copolymer, a cyclic polyester oligomer, and a transesterification catalyst, said material including nodules of polyester.

The Applicant has discovered, surprisingly, that incorporating a cyclic polyester oligomer in an elastomer composition based on EVA in the presence of a transesterification catalyst makes it possible to obtain a material having optimized mechanical, thermal, and chemical properties.

In particular, said material presents very good resistance to oils and solvents.

Advantageously, cyclic oligomers of polyester present sufficient miscibility with EVA to enable homogenous elastomer mixtures to be obtained at a temperature lower than the degradation temperature of EVA (220° C.).

Furthermore, the polymerization of the cyclic polyester oligomer into polyester takes place by thermal activation in situ, i.e. directly in the EVA-based matrix, thus forming polyester nodules that are dispersed uniformly throughout said material.

In other words, the polyester nodules constitute hard particles in situ, i.e. within the elastomer composition, with the particles being of a diameter of less than one micrometer.

In addition, the vinyl acetate groups of the EVA are essential for encouraging miscibility with the cyclic polyester oligomer.

The transesterification catalyst makes it possible to accelerate the kinetics with which the cycle of the cyclic polyester oligomer is opened, and it also serves advantageously to create chemical bonds between the vinyl acetate groups and the cyclic polyester oligomer.

The material obtained in this way presents mechanical, thermal, and chemical properties that are very good.

### OBJECT AND SUMMARY OF THE INVENTION

In a particularly preferred implementation, said material is subsequently extruded to form a layer forming part of a power and/or telecommunications cable.

Using an extrusion method is not limiting and said layer of said material could equally well be formed by using any other method well known to the person skilled in the art.

In another implementation, the elastomer composition may be extruded directly to form said layer.

Under such circumstances, the thermal activation of said composition takes place while it is being extruded.

Regardless of whether a cable is electrical or optical, is for transporting power or for transmitting data, it is constituted, in outlines, by at least one electrical or optical conductor element lying within at least one insulating or protective element.

It should be observed that at least one of the insulating elements may also perform a specific protection function constituting a sheath, in particular for electric cables.

In the present invention, the layer may be an insulating layer or a protective sheath, and preferably it is a protective sheath.

In a particular implementation, the elastomer composition comprises at least 40% by weight of ethylene vinyl acetate copolymer.

This quantity makes it possible to retain sufficient mechanical properties specific to EVA in the elastomer composition.

Preferably, the elastomer composition has 70% by weight of EVA.

Naturally, the elastomer composition may include one or more different polymers other than EVA, nevertheless EVA must remain in the majority relative to those polymers so as to avoid degrading the elastomeric properties of said composition.

According to a particular feature of the present invention, the ethylene vinyl acetate copolymer comprises at least 19% by weight of vinyl acetate groups, preferably 28% by weight of vinyl acetate groups.

The cyclic polyester oligomer is typically a cyclic poly(alkylene dicarboxylate) oligomer as described in patent document WO 2005/063882, incorporated by reference.

In a particularly advantageous implementation, the cyclic polyester oligomer is selected from the cyclic oligomers of: poly(1,4-butylene terephthalate) (cPBT); poly(ethylene terephthalate) (cPET); poly(1,3-propylene terephthalate) (cPPT); poly(1,4-cyclohexylenedimethylene terephthalate) (cPCT); and poly(1,2-ethylene 2,6-naphthalenedicarboxylate) (cPEN).

Preferably, the cyclic polyester oligomer is cPBT.

In another particular implementation, the elastomer composition has no more than 50% by weight of cyclic polyester oligomer.

In particularly advantageous manner, the weight ratio of EVA to cyclic polyester oligomer is equal to 70/30.

In another particular implementation, the elastomer composition contains catalyst in the range 0.5 parts by weight per 100 parts (pph) of polymer in said composition to 2 pph, and preferably 1 pph.

The transesterification catalyst is typically a catalyst based on titanium or tin, as described in patent document WO 2005/063882, incorporated by reference.

Preferably, said catalyst is titanium tetrabutoxide.

In a particular preferred implementation, the elastomer composition of the present invention may initially be homogenized at a homogenizing temperature equal to the melting temperature of the cyclic polyester oligomer.

This homogenizing temperature serves advantageously to optimize miscibility of the cyclic polyester oligomer in the EVA matrix, with the activation of polymerization of said oligomer by the catalyst being practically non-existing at this temperature.

Preferably, the homogenizing temperature is equal to about 160° C.

Thereafter, after the homogenizing step, the thermal activation of the elastomer composition takes place at an activation temperature higher than the melting temperature of the cyclic polyester oligomer and at a temperature of less than 220° C. in order to enable the cyclic polyester oligomer to polymerize in the elastomer composition, thereby forming the material including polyester nodules.

The activation temperature advantageously enables the opening of the cycles of the cyclic oligomers of polyester to be activated in the presence of the catalyst.

Preferably, the activation temperature is equal to about 190° C.

The homogenizing and activation steps do not necessarily depend one on the other, and in particular the homogenizing step can be optional.

The present invention also provides a power and/or telecommunications cable including at least one layer obtained from said method as defined above.

### MORE DETAILED DESCRIPTION

Other characteristics and advantages of the present invention appear in the light of the following examples, said examples being given by way of non-limiting illustration.

In order to show the advantages of the materials obtained from elastomer compositions of the present invention, Table 1 gives the ingredients of seven different compositions having mechanical properties that have been studied.

The quantities mentioned in Table 1 are expressed in parts by weight per 100 parts (pph) of polymer in the composition.

Composition A corresponds to a composition of the present invention and compositions B to G correspond to comparative compositions.

TABLE 1

| Compositions | A | B | C | D | E | F | G |
|---|---|---|---|---|---|---|---|
| Elvaloy3427 | | | | | | 70 | 70 |
| LL1004 | | | | 70 | 70 | | |
| Elvax265 | 70 | 100 | 70 | | | | |
| CBT X03 | 30 | | | | 30 | | 30 |
| Ti(OBu)₄ | 1 | | | | 1 | | 1 |
| Vestodur3013 | | | 30 | 30 | | 30 | |

The ingredients of compositions A to G have the following origins:

Elvaloy3427 is the reference of an ethylene butyl acrylate (EBA) copolymer having 17% butyl acrylate groups, sold by the supplier Dupont Dow;

LL1004 is the reference of a low density polyethylene (LDPE) sold by the supplier Exxon;

Elvax265 is the reference of an ethylene vinyl acetate (EVA) copolymer having 28% of vinyl acetate groups, sold by the supplier Dupont;

CBTX3 is the reference of a cyclic polybutylene terephthalate (cPBT) oligomer sold by the supplier Cyclics;

Ti(OBu)₄ is a titanium tetrabutoxide catalyst sold by the supplier Aldrich; and

Vestodur3013 is a polybutylene terephthalate (PBT) from the supplier Degussa.

Composition A, and compositions E and G were worked at 50 revolutions per minute (rpm) in an internal mixer at a mixture-homogenizing temperature set at 160° C.

That temperature enables the cPBT to melt in the EVA, LDPE, or EBA matrix of compositions A, E, and G, since the melting temperature of cPBT lies in the range 120° C. to 160° C.

After mixing for 20 minutes, the titanium catalyst was added and mixing was continued for 60 minutes at 160° C.

During the homogenizing step, with mixture A, the good compatibility between EVA and cPBT makes mixing much easier and more homogenous.

Thus, said cyclic polyester oligomer is miscible and well dispersed in the elastomer composition.

With compositions E and G, it is difficult to homogenize the mixture correctly because of a high level of lubrication, or in other words poor miscibility, induced by the cPBT before it reacts.

After said homogenizing step, the temperature was set at 190° C. (activation temperature) for 20 minutes in order to polymerize the cPBT into PBT (composition A), since EVA is not degraded at that temperature.

Composition B is the reference composition for mechanical properties since it comprises EVA only.

Compositions C, D, and F, including PBT were worked at 50 rpm in an internal mixer with the temperature of the mixture set at 220° C. for 20 minutes, that temperature enabling the PBT to melt.

The resulting materials A to G were subsequently put into a press at a temperature of 140° C. in order to form plates having a thickness of 1 millimeter (mm).

Those plates were suitable for making H2 type testpiece samples in compliance with ISO standard 527-1 in order to perform traction type mechanical tests.

The traction tests were performed on said testpieces at a traversing speed of 100 millimeters per minute (mm/min).

Those tests serve to measure mechanical properties such as breaking stress and elongation at break for the samples A to G.

The results are summarized in Table 2 below.

TABLE 2

| Sample | A | B | C | D | E | F | G |
|---|---|---|---|---|---|---|---|
| Breaking | 18 | 12 | 8 | 7 | 7 | 3 | 3 |
| stress (MPa) | | | | | | | |
| Elongation at | 1100 | 1600 | 300 | 115 | 167 | 244 | 218 |
| break (%) | | | | | | | |

As can be seen, from a mechanical point of view, only the EVA/cPBT mixture (sample A) shows better breaking stress than samples B to G.

More particularly, sample A presents a breaking stress nearly 50% better than that of sample B and mechanical properties much better than those of an EVA/PBT mixture (sample C).

In addition, the chemical resistance of mixtures A to C was evaluated by measuring the amount of swelling (in % by volume) of an H2 type traction testpiece after spending 1 week at 100° C. in a standardized ASTM 3 oil.

It was observed that mixture A was caused to swell by the oil, but that the testpiece retained its integrity, unlike samples B and C which broke down completely.

Insolubles from samples A and C after spending 2 days in tetrahydrofuran (THF) were analyzed under a scanning electron microscope which revealed the morphology of the PBT phase formed within the mixtures.

Thus, the size of the particles (nodules) of PBT formed by polymerization within the EVA (sample A) was smaller than in an EVA/PBT mixture (sample C), the diameter of the particles in the mixture A being less than 1 micrometer.

The present invention is not limited to the elastomer composition examples described above and it relates in general to all materials that can be envisaged from the general indications given in the description of the invention.

What is claimed is:

1. A method of fabricating a power and/or telecommunications cable, said method comprising the steps of:
obtaining at least one layer of material by thermally activating an elastomer composition containing an ethylene vinyl acetate copolymer, a cyclic polyester oligomer, and a transesterification catalyst, wherein said material including nodules of polyester.

2. A method according to claim 1, wherein the elastomer composition is at least 40% by weight of ethylene vinyl acetate copolymer.

3. A method according to claim 1, wherein the ethylene vinyl acetate copolymer comprises at least 19% by weight of vinyl acetate groups.

4. A method according to claim 1, wherein the cyclic polyester oligomer is selected from the group of cyclic oligomers consisting of: poly(1,4-butylene terephthalate); poly(ethylene terephthalate); poly(1,3-propylene terephthalate); poly(1,4-cyclohexylenedimethylene terephthalate); and poly(1,2-ethylene 2,6-naphthalenedicarboxylate).

5. A method according to claim 1, wherein the elastomer composition has no more than 50% by weight of cyclic polyester oligomer.

6. A method according to claim 1, wherein the weight ratio of EVA to cyclic polyester oligomer is equal to 70/30.

7. A method according to claim 1, wherein the elastomer composition contains catalyst in the range 0.5 parts by weight per 100 parts of polymer in said composition to 2 pph.

8. A method according to claim 1, wherein the thermal activation is performed at an activation temperature higher than the melting temperature of the cyclic polyester oligomer and at a temperature less than 220° C.

9. A method according to claim 8, wherein the activation temperature is equal to about 190° C.

10. A method according to claim 1, wherein the activation step is preceded by a step of homogenizing the elastomer composition at a homogenizing temperature equal to the melting temperature of the cyclic polyester oligomer.

11. A method according to claim 10, wherein the homogenizing temperature is equal to about 160° C.

12. A power and/or telecommunications cable including at least one layer obtained by a method as defined in claim 1.

13. A method according to claim 2, wherein the elastomer composition is at least 70% by weight of ethylene vinyl acetate copolymer.

14. A method according to claim 3, wherein the ethylene vinyl acetate copolymer comprises at least 28% by weight of vinyl acetate groups.

15. A method according to claim 7, wherein the elastomer composition contains catalyst in the range 0.5 parts by weight per 100 parts of polymer in said composition to 1 pph.
